(19) United States
(12) Patent Application Publication
(10) Pub. No.: US 2025/0330891 A1
(43) Pub. Date: Oct. 23, 2025

(54) HANDLING SECURITY KEYS DURING CONDITIONAL PRIMARY-SECONDARY-CELL (PSCELL) CHANGE WITHOUT ADDITIONAL RADIO RESOURCE CONTROL SIGNALING TO A USER EQUIPMENT (UE)

(71) Applicant: Apple Inc., Cupertino, CA (US)

(72) Inventors: Naveen Kumar R. Palle Venkata, San Diego, CA (US); Haijing Hu, Los Gatos, CA (US); Fangli Xu, Beijing (CN); Yuqin Chen, Beijing (CN); Peng Cheng, Beijing (CN); Pavan Nuggehalli, San Carlos, CA (US); Shu Guo, Beijing (CN); Alexander Sirotkin, Herzliya (IL); Ralf Rossbach, Munich (DE); Zhibin Wu, Los Altos, CA (US); Ping-Heng Kuo, London (GB)

(21) Appl. No.: 18/992,748

(22) PCT Filed: Jul. 14, 2022
(86) PCT No.: PCT/CN2022/105743

§ 371 Date: Jan. 9, 2025

(51) Int. Cl. H04W 36/36; H04W 12/041; H04W 76/10; H04W 76/30

(52) U.S. Cl. CPC H04W 36/362; H04W 12/041; H04W 76/10; H04W 76/30

(57) ABSTRACT

A user equipment (UE) includes a transceiver and a processor, which is configured to connect the UE, via the transceiver, with a plurality of radio access network (RAN) nodes including at least a master node for the UE, and at least a first secondary node and a second secondary node for the UE. The processor is configured to receive, from the master node, secondary cell group (SCG) configuration information including a respective security configuration structure for each secondary node of the at least two secondary nodes. After satisfying a conditional primary secondary cell (PSCell) change condition associated with connecting to a first secondary node, the processor is configured to derive a secondary node security key (K_{SN}) corresponding to the first secondary node using a first security configuration structure associated with the first secondary node, and update and communicate a second security configuration structure associated with a second secondary node.

### TECHNICAL FIELD

This application relates generally to wireless communication systems, including methods and systems for handling security during user equipment (UE) mobility and, in particular, handling security keys during multiple primary-secondary-cell (PSCell) changes without additional radio resource control (RRC) signaling to a UE.

### BACKGROUND

Wireless mobile communication technology uses various standards and protocols to transmit data between a base station and a wireless communication device. Wireless communication system standards and protocols can include, for example, 3rd Generation Partnership Project (3GPP) long term evolution (LTE) (e.g., 4G), 3GPP new radio (NR) (e.g., 5G), and IEEE 602.11 standard for wireless local area networks (WLAN) (commonly known to industry groups as Wi-Fi®).

As contemplated by the 3GPP, different wireless communication systems standards and protocols can use various radio access networks (RANs) for communicating between a base station of the RAN (which may also sometimes be referred to generally as a RAN node, a network node, or simply a node) and a wireless communication device known as a UE. 3GPP RANs can include, for example, global system for mobile communications (GSM), enhanced data rates for GSM evolution (EDGE) RAN (GERAN), Universal Terrestrial Radio Access Network (UTRAN), Evolved Universal Terrestrial Radio Access Network (E-UTRAN), and/or Next-Generation Radio Access Network (NG-RAN).

Each RAN may use one or more radio access technologies (RATs) to perform communication between the base station and the UE. For example, the GERAN implements GSM and/or EDGE RAT, the UTRAN implements universal mobile telecommunication system (UMTS) RAT or other 3GPP RAT, the E-UTRAN implements LTE RAT (sometimes simply referred to as LTE), and NG-RAN implements NR RAT (sometimes referred to herein as 5G RAT, 5G NR RAT, or simply NR). In some deployments, the E-UTRAN may also implement NR RAT. In some deployments, NG-RAN may also implement LTE RAT.

A base station used by a RAN may correspond to that RAN. One example of an E-UTRAN base station is an Evolved Universal Terrestrial Radio Access Network (E-UTRAN) Node B (also commonly denoted as evolved Node B, enhanced Node B, eNodeB, or eNB). One example of an NG-RAN base station is a next generation Node B (also sometimes referred to as a g Node B or gNB).

A RAN provides its communication services with external entities through its connection to a core network (CN). For example, E-UTRAN may utilize an Evolved Packet Core (EPC), while NG-RAN may utilize a 5G Core Network (5GC).

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 shows an example wireless communication system, according to embodiments described herein.

FIG. 2 illustrates a message flow of a legacy cell group (CG) change mechanism.

FIG. 3 illustrates an example message flow of a CG change mechanism, according to embodiments described herein.

FIG. 4 illustrates another example message flow of a CG change mechanism, according to embodiments described herein.

FIG. 5 illustrates another example message flow of a CG change mechanism, according to embodiments described herein.

FIG. 6 illustrates an example flow-chart of operations being performed by a UE, according to embodiments described herein.

FIG. 7 illustrates another example flow-chart of operations being performed by a UE, according to embodiments described herein.

FIG. 8 illustrates an example flow-chart of operations being performed by a base station, according to embodiments described herein.

FIG. 9 illustrates an example architecture of a wireless communication system, according to embodiments described herein.

FIG. 10 illustrates a system for performing signaling between a wireless device and a network device, according to embodiments described herein.

### DETAILED DESCRIPTION

In the present disclosure, various embodiments are related to handling security keys during a conditional PSCell change (CPC) procedure in a connected state of a UE. Currently, during each PSCell change in the connected state of the UE, security keys are exchanged with the UE using level-3 signaling, for example, RRC signaling. In other words, the UE is reconfigured for security keys each time there is a PSCell change. Various embodiments described herein eliminate a need for reconfiguring the UE for a secure connection with one or more PSCells, which may also be referred herein as a secondary node (SN), during the CPC procedure. An MN and/or an SN may be a base station.

In 3GPP Technical Specification (TS) 37.340 Release 17, a conditional PSCell addition (CPA) procedure was introduced, and according to which a network may configure multiple candidate secondary cell groups (SCGs) for a UE for an SCG addition. For each candidate SCG, a network and/or a master node (MN) may also provide one or more radio conditions that need to be met for connecting to a particular SCG. As the UE performs evaluation of the one or more radio conditions for each candidate SCG, the UE may add a particular SCG upon fulfillment of the one or more radio conditions configured by the network and/or the MN. Once the particular SCG is added by the UE, the UE releases a configuration related to all other candidate SCGs. Accordingly, reconfiguration of the UE is needed for a subsequent CPA mechanism for the UE to add another SCG or CPC mechanism for the UE to switch to another SCG.

A UE may also perform an intra-SN CPC mechanism, an inter-SN CPC mechanism, and/or an MN/SN initiated CPC mechanism, as described in TS 37.340 Release 17, and according to which the UE may perform an evaluation of one or more radio conditions for an intra-SN CPC mechanism, an inter-SN CPC mechanism, and/or an MN/SN initiated CPC mechanism. Upon fulfillment of the one or more conditions corresponding to the intra-SN CPC mechanism, the inter-SN CPC mechanism, and/or the MN/SN initiated CPC mechanism, and upon completion of the intra-SN CPC mechanism, the inter-SN CPC mechanism, and/or the MN/SN initiated CPC mechanism, the UE may release a configuration related to SCGs to which the UE is not currently connected. Accordingly, reconfiguration of the UE is needed for a subsequent intra-SN CPC mechanism, inter-SN CPC mechanism, and/or MN/SN initiated CPC mechanism.

For a secure connection with a primary cell (PCell), the MN may provide the UE with a security configuration to derive a security key corresponding to a base station or an MN (K_{gNB}). The MN may also provide the UE with sk_counter corresponding to each candidate SN as part of an SN addition procedure and/or an SN change procedure. The UE may use the KgNB and sk_counter to derive a K_{SN} in order to further derive a cipher key (CK) and an integrity key (IK) for a secure bearer connection, e.g., a data radio bearer (DRB) connection, or a signaling radio bearer (SRB), which terminates at an SN packet data convergence protocol (PDCP) layer. The MN also derives a K_{SN} using the KgNB and a respective sk_counter corresponding to each SN and provides the derived K_{SN} to each respective SN (or PSCell). The SN uses received K_{SN} to derive a CK and an IK for the secure bearer connection with the UE. The security configuration may be also referred to as a CPC configuration in the present disclosure.

In a legacy cell group (CG) change mechanism, the UE is mandated to release a configuration, including a security configuration, related to a source CG upon completion of the CG change mechanism. Accordingly, the UE is mandated to release the sk_counter after applying it, and the MN needs to provide a new sk_counter to the UE, and a new K_{SN} to each candidate PSCell or SN each time whenever there is a change in an SN (or PSCell).

Even though to avoid this reconfiguration of the UE each time whenever there is a change in an SN (or PSCell), if the UE is configured to save the previous configuration corresponding to each SCG, the UE may end up reusing the same K_{SN} when the UE returns back to the same SN (or PSCell), which may pose a security risk.

Various embodiments described in the present disclosure provide solutions eliminating a need to reconfigure the UE with a security configuration each time whenever there is a change in an SN (or PSCell), and also assuring that a new K_{SN} is used by the UE when the UE returns back to the same SN (or PSCell) to which the UE may be once connected earlier.

Reference will now be made in detail to representative embodiments/aspects illustrated in the accompanying drawings. It should be understood that the following description is not intended to limit the embodiments to one preferred embodiment. On the contrary, it is intended to cover alternatives, combinations, modifications, and equivalents as can be included within the spirit and scope of the described embodiments as defined by the appended claims.

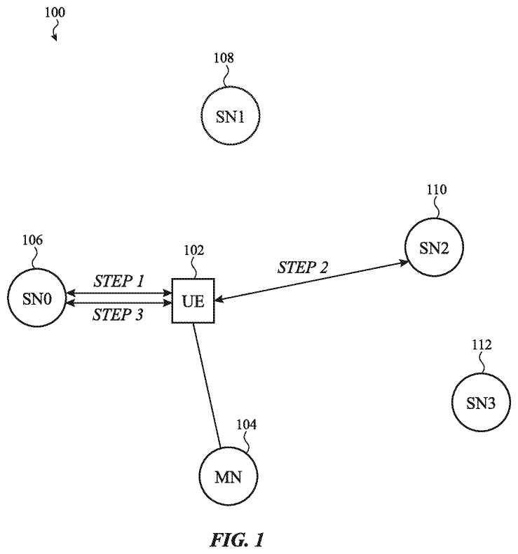

FIG. 1 shows an example wireless communication system, according to embodiments described herein. As shown in FIG. 1, a wireless communication system 100 may include a UE 102, an MN 104, and two or more SNs, for example, an SN0 106, an SN1 108, an SN2 110, and/or an SN3 112. An SN, in the present disclosure, may also be referenced as a PSCell.

In a dual connectivity mode, the UE 102 may be connected to the MN 104, and at least one of the SNs 106, 108, 110, and 112. For example, the UE 102 may be initially connected to the MN 104 and the SN0 106, as shown in FIG. 1 as step 1. As the UE 102 is moving, one or more radio conditions at the UE 102 may change, which may cause the UE 102 to connect to the SN2 110, as shown in FIG. 1 as step 2. And, as the radio conditions at the UE 102 change again, for example, the UE 102 may connect to the SN0 106 again, as shown in FIG. 1 as step 3.

As described herein, the UE 102 may be provided a configuration related to each candidate SN (or SCG), e.g., each SN to which the UE may be connected in a dual connectivity (DC) mode. The configuration related to each candidate SN may also include a security configuration, which may include an sk_counter corresponding to that SN, and a K_{gNB} corresponding to the MN 104. As described herein, the UE may use an sk_counter corresponding to a particular SN for which one or more radio conditions are met at the UE 102 and the K_{gNB} to derive a CK and an IK for a secure bearer connection, e.g., a DRB connection, or an SRB connection, which terminates at an SN PDCP layer of the particular SN. The one or more radio conditions may be configured at the UE 102 by the MN 104. The MN 104 may also derive a K_{SN} using the K_{gNB} and a respective sk_counter corresponding to each SN, and provide the derived K_{SN} to each respective SN (or PSCell). The SN may use the received K_{SN} to derive a CK and an IK for a secure bearer connection (e.g., a DRB connection, or an SRB connection) with a UE.

As shown in FIG. 1, at step 1, the one or more radio conditions configured by the MN 104 for the UE 102 to connect with an SN may be met with respect to the SN0 106. The UE 102, accordingly, may use an sk_counter associated with the SN0 106 along with the KgNB to derive a K_{SN} to have a secure bearer connection with the SN0 106 following a random access channel (RACH) procedure performed with the SN0 106. The UE 102 may then inform the MN 104 that the UE 102 is now in a DC mode with the SN0 106 and the MN 104, and delete or remove the configuration, including the security configuration, associated with other candidate SNs, for example, the SN1 108, the SN2 110, the SN3 112.

The UE 102 may be provided a new configuration related to each candidate SN (or SCG). The new configuration related to each candidate SN may include a security configuration, which includes a new sk_counter corresponding to each candidate SN, and a K_{gNB} corresponding to the MN 104. As described herein, the UE may use the new sk_counter corresponding to a particular SN for which one or more radio conditions are met at the UE 102 and the K_{gNB} to derive a CK and an IK for a secure bearer connection, e.g., a DRB connection, or an SRB connection, which terminates at an SN PDCP layer of the particular SN. As described herein, the one or more radio conditions may be configured at the UE 102 by the MN 104. The MN 104 may also derive a K_{SN} using the KgNB and a respective new sk_counter corresponding to each SN, and provide the derived K_{SN} to each respective SN (or PSCell). The SN may use the received K_{SN} to derive a CK and an IK for a secure bearer connection with a UE.

As the UE 102 moves, the one or more radio conditions configured by the MN 104 for the UE 102 to connect with an SN may be met with respect to the SN2 110, as shown in FIG. 1, as step 2. The UE may then initiate and perform a RACH procedure with the SN2 110, and establish a secure bearer connection with the SN2 110 using a K_{SN} derived from a new sk_counter corresponding to the SN2 110 and the KgNB. The UE may also remove a configuration, including a security configuration, related to other SNs, for example, the SN1 108, the SN0 106, and the SN3 112, and inform the MN 104 that the UE 102 is now in a DC mode with the MN 104 and the SN2 110.

The UE 102 may be again provided a new configuration related to each candidate SN (or SCG). The new configuration related to each candidate SN may include a security configuration, which includes another new sk_counter corresponding to each SN, and a K_{gNB} corresponding to the MN 104. The MN 104 may also derive another K_{SN} using the KgNB and a current sk_counter corresponding to each SN, and provide the derived K_{SN} to each respective SN (or PSCell) for a secure bearer connection with a UE.

As shown in FIG. 1, as step 3, the UE 102 may find one or more radio conditions are met with respect to the SN0 106 requiring the UE to connect with the SN0 106 again. The UE may repeat the steps, as described herein, to establish a secure bearer connection with the SN0 106.

As described herein, the MN 104 needs to reconfigure the UE 102 for a configuration, including a security configuration, for each candidate SN once the UE connects with a particular SN following a CPC procedure. The MN 104 configures or reconfigures the UE 102 using level-3 signaling, such as RRC signaling.

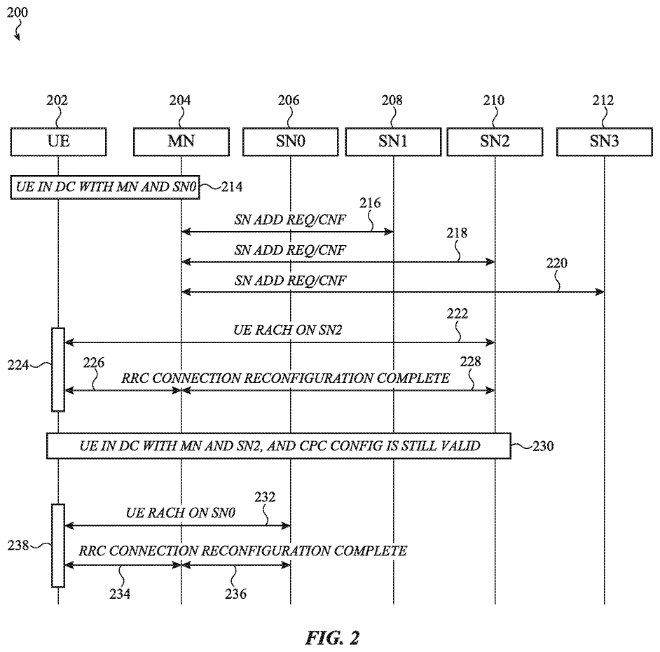

Even if the UE 102 is configured not to delete or remove the security configuration corresponding to other candidate SNs after establishing a dual connectivity with the MN 104 and at least one SN, when the UE establishes a dual connectivity with an SN, to which the UE has been previously connected, the UE may be using a stale K_{SN}, which would cause failure in establishing a secure connection with the SN, as described in FIG. 2 below, if the MN 104 may have provided a new K_{SN} to the candidate SNs. In some cases, if the MN 104 has not provided a new K_{SN} to the candidate SNs, the UE and the SN may be using the same K_{SN} to establish a secure connection each time, which may pose a security risk.

FIG. 2 illustrates a message flow of a legacy cell group (CG) change mechanism. As shown in FIG. 2, a message flow 200 illustrates messages exchanged between a UE 202, an MN 204, and two or more SNs, for example, an SN0 206, an SN1 208, an SN2 210, and an SN3 212. As shown in the message flow 200 as 214, the UE 202 is in a dual connectivity (DC) mode with the MN 204 and the SN0 206 using the CPA procedure mentioned in the present disclosure. Further, the MN 204 may transmit to each of the other SNs, the SN1 208, the SN2 210, and the SN3 212, a configuration and request corresponding to establishing a secure connection with the UE 202, which is shown in FIG. 2 as 216, 218, and 220, respectively.

As described herein, in accordance with some embodiments, at 224, the UE 202 may determine that one or more radio conditions are met with respect to the SN2 210, and the UE may perform a CPC procedure to connect to the SN2 210, in which the UE 202 may perform a RACH procedure with the SN2 210, shown in FIG. 2 as 222. Upon successful completion of the RACH procedure with the SN2 210, the UE 202 may transmit an RRC connection reconfiguration complete message to the MN 204 as shown in FIG. 2 as 226, and the MN 204 may also transmit an RRC connection reconfiguration complete message to the SN2 210 as shown in FIG. 2 as 228. The RRC connection reconfiguration complete message from the UE 202 to the MN 204 may indicate to the MN 204 that the UE 202 is now in a DC mode with the SN2 210.

At 224, the UE 202 may save the security configuration associated with the SN0 206 instead of deleting the security configuration so that the UE 202 may reuse the security configuration associated with the SN0 206 later while connecting with the SN0 206 again when one or more radio conditions specified by the MN 204 are met again with respect to the SN0 206. In some cases, the UE 202 may also save the security configuration associated with the SN1 208 and the SN3 212.

As shown in the message flow 200, at 230, the UE 202 is in DC mode with the MN 204 and the SN2 210, and the security configuration is valid for the SN1 208, the SN2 210, and the SN3 212, but the security configuration corresponding to the SN0 206 is invalid as described below. At 230, the MN 204 may transmit to each of the other SNs, the SN1 208, the SN0 206, and the SN3 212, a configuration and request for establishing a secure connection with the UE 202. However, the configuration and request for establishing a secure connection between the UE 202 and the SN0 206 transmitted to the SN0 206 may be generated by the MN 204 using a different value of an sn_counter than previously used and saved by the UE 202 at 224.

At 238, the UE 202 may determine that if one or more radio conditions are met with respect to the SN0 206 again, the UE 202 may perform the CPC mechanism to connect to the SN0 206, and the UE 202 may perform RACH procedure 232 with the SN0 206. Upon successful completion of the RACH procedure 232 with the SN0 206, the UE 202 may transmit an RRC connection reconfiguration complete message to the MN 204 as shown in FIG. 2 as 234, and the MN 204 may also transmit an RRC connection reconfiguration complete message to the SN0 206 as shown in FIG. 2 as 236. However, the RRC connection reconfiguration complete message 236 from the MN 204 to the SN0 206 would not be successful as the SN0 206 and the UE 202 each is using a different sn_counter value for generating a K_{SN} for establishing a secure connection.

In some embodiments, even if the MN 204 is configured to not send a new security configuration based on an updated value of an sn_counter to a candidate SN, the UE 202 and the SN0 206 may then end up using the same K_{SN} for establishing a secure connection, which may not be as secure as expected because the same K_{SN} is being used each time.

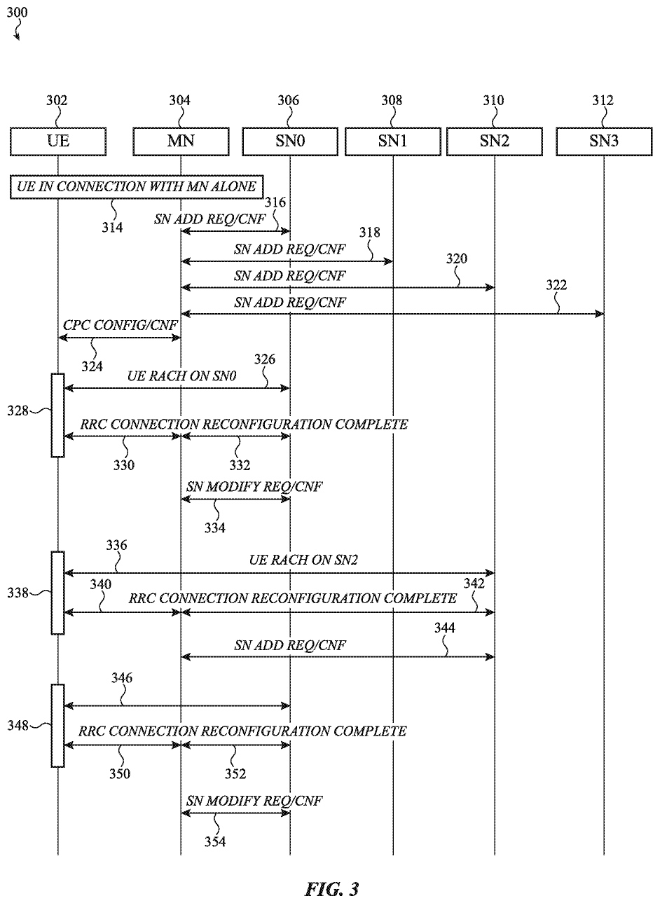

Various solutions in accordance with some embodiments are described herein using FIG. 3 through FIG. 5 below.

FIG. 3 illustrates an example message flow of a CG change mechanism, according to embodiments described herein. As shown in FIG. 3, a message flow 300 illustrates messages exchanged between a UE 302, an MN 304, and two or more SNs, for example, an SN0 306, an SN1 308, an SN2 310, and an SN3 312. As shown in the message flow 300 as 314, the UE 302 may initially be connected with the MN 304. The MN 304 may determine or identify candidate SNs, for example, the SN0 306, the SN1 308, the SN2 310, and the SN3 312, and may transmit a configuration and request to establish a secure connection with the UE 302, which is shown in FIG. 3 as 316, 318, 320, and 322, respectively. The configuration transmitted by the MN 304 to each of the SN0 306, the SN1 308, the SN2 310, and the SN3 312 may include a respective K_{SN} for each of the SN0 306, the SN1 308, the SN2 310, and the SN3 312.

The MN 304 may also transmit a security configuration to the UE 302 that is shown in FIG. 3 as 324. The security configuration transmitted by the MN 304 to the UE 302 at 324 may include a secondary node key counter (K_{SN}-Counter, also referenced in the present disclosure as sn_counter) corresponding to each candidate SN, and a secondary node key offset (K_{SN}-Offset) corresponding to each candidate SN. The UE 302 may use the received the K_{SN}-Counter and/or K_{SN}-Offset associated with an SN, for which one or more radio conditions specified by the MN 304 are satisfied at the UE 302, to derive a K_{SN} for establishing a secure connection with the SN.

In some embodiments, and by way of a non-limiting example, the UE 302 may be configured, for example, by the MN 304, to derive a K_{SN} for an SN using the K_{SN}-Counter, and once the UE establishes the DC mode with an SN, the UE may update the K_{SN}-Counter using the K_{SN}-Offset, and then the updated K_{SN}-Counter may be used for subsequent connection with the SN when the UE connects to the same SN after being connected with another SN. Accordingly, the UE may use a different K_{SN}-Counter while connecting with the same SN again.

In some embodiments, and by way of a non-limiting example, the UE 302 may be configured, for example, by the MN 304, to derive a K_{SN} for an SN using a K_{SN}-Counter and K_{SN}-Offset before the UE establishes a DC mode with an SN. Accordingly, the UE may generate a unique K_{SN} for the SN each time the UE is connecting with the same SN. In this case, the MN 304 may send a respective K_{SN} to each candidate SN by updating the K_{SN}-Counter using the K_{SN}-Offset for each candidate SN. The MN 304 may also indicate to the candidate SNs to use the K_{SN} to establish a secure connection with the UE 302.

As shown in FIG. 3, at 328, the UE 302 may determine that one or more radio conditions as specified by the MN 304 for connecting with an SN or a CPC procedure are satisfied with respect to the SN0 306. The UE 302 may, therefore, perform a RACH procedure 326 to connect with the SN0 306, or to establish a DC mode with the MN 304 and the SN0 306. The UE 302 may transmit RRC connection reconfiguration complete 330 to the MN 304 to inform the MN 304 that the UE is now connected with the SN0 306, and the MN 304 may transmit RRC connection reconfiguration complete 332 to the SN0 306.

As described herein, in accordance with some embodiments, after establishing a DC mode with the SN0 306 and the MN 304, the UE 302 may update the K_{SN}-Counter associated with the SN0 306 using the K_{SN}-Offset associated with the SN0 306. As shown in FIG. 3 as 334, the MN 304 may regenerate the K_{SN} for the SN0 306 based on the K_{SN}-Counter associated with the SN0 306 that is updated using the K_{SN}-Offset associated with the SN0 306, and transmit to the SN0 306 the regenerated K_{SN} for the SN0 306 for establishing a secure connection with the UE 302 when the UE 302 connects to the SN0 306 again after connecting with another SN, for example, the SN2 310. Additionally, or alternatively, the MN 304 may also indicate to the SN0 306 that the K_{SN} transmitted by the MN 304 to the SN0 306 at 334 is not to be used during the current connection between the SN0 306 and the UE 302, but for the subsequence future connection.

As shown in FIG. 3, at 338, the UE 302 may determine that one or more radio conditions as specified by the MN 304 for connecting with an SN or an SN change are satisfied with respect to the SN2 310. The UE 302 may, therefore, perform a RACH procedure 336 to connect with the SN2 310, or to establish a DC mode with the MN 304 and the SN2 310. The UE 302 may transmit RRC connection reconfiguration complete 340 to the MN 304 to inform the MN 304 that the UE is now connected with the SN2 310, and the MN 304 may transmit RRC connection reconfiguration complete 342 to the SN2 310.

The UE 302 may use the received K_{SN}-Counter and/or K_{SN}-Offset associated with the SN2 310 to derive a K_{SN} for establishing a secure connection with the SN2 310. As described herein, in some embodiments, and by way of a non-limiting example, the UE 302 may derive a K_{SN} associated with the SN2 310 using a K_{SN}-Counter associated with the SN2 310, and once the UE 302 establishes a DC mode with the SN2 310, the UE 302 may update the K_{SN}-Counter using the K_{SN}-Offset associated with the SN2 310. The UE 302 may then use the updated K_{SN}-Counter for subsequent connection with the SN2 310 when the UE 302 connects to the SN2 310 after being connected with another SN, for example, the SN0 306, the SN1 308, and/or the SN3 312. Accordingly, the UE 302 may use a different K_{SN}-Counter while connecting with the SN2 310.

In some embodiments, and by way of a non-limiting example, the UE 302 may be configured, for example, by the MN 304, to derive a K_{SN} for establishing a secure connection with the SN2 310 using the K_{SN}-Counter and K_{SN}-Offset associated with the SN2 310 before the UE establishes a DC mode with the SN2 310. Accordingly, the UE 302 may generate a unique K_{SN} for the SN2 310 each time the UE 302 is connecting with the SN2 310. In this case, a K_{SN} transmitted to the SN2 310 may be based on a K_{SN}-Counter associated with the SN2 310 that is updated based on a K_{SN}-Offset associated with the SN2 310.

As described herein, in accordance with some embodiments, after establishing a DC mode with the SN2 310 and the MN 304, the UE 302 may update the K_{SN}-Counter associated with the SN2 310 using the K_{SN}-Offset associated with the SN2 310. As shown in FIG. 3 as 344, the MN 304 may regenerate a K_{SN} for the SN2 310 based on the K_{SN}-Counter associated with the SN2 310 that is updated using the K_{SN}-Offset associated with the SN2 310, and transmit to the SN2 310 the regenerated K_{SN} for the SN2 310 for establishing a secure connection with the UE 302 when the UE 302 connects to the SN2 310 again after connecting with another SN, for example, the SN0 306, the SN1 308, and/or the SN3 312. Additionally, or alternatively, the MN 304 may also indicate to the SN2 310 that the K_{SN} transmitted by the MN 304 to the SN2 310 at 344 is not to be used during the current connection between the SN2 310 and the UE 302, but for the subsequence future connection.

As shown in FIG. 3, at 348, the UE 302 may determine that one or more radio conditions as specified by the MN 304 for connecting with the SN0 306 are satisfied. The UE 302 may, therefore, perform a RACH procedure 346 to connect with the SN0 306, or to establish a DC mode with the MN 304 and the SN0 306. The UE 302 may transmit RRC connection reconfiguration complete 350 to the MN 304 to inform the MN 304 that the UE is now connected with the SN0 306, and the MN 304 may transmit RRC connection reconfiguration complete 352 to the SN0 306.

The UE 302 may use the K_{SN}-Counter and/or K_{SN}-Offset associated with the SN0 306 to derive a K_{SN} for establishing a secure connection with the SN0 306, as described herein, in accordance with some embodiments, at step 328. Accordingly, the UE 302 may generate and use a unique K_{SN}, at 348, to connect with the SN0 306.

As shown in FIG. 3 as 354, the MN 304 may regenerate a K_{SN} for the SN0 306 based on the K_{SN}-Counter associated with the SN0 306 that is updated using the K_{SN}-Offset associated with the SN0 306, and transmit to the SN0 306 the regenerated K_{SN} for the SN0 306 for establishing a secure connection with the UE 302 when the UE 302 connects to the SN0 306 again after connecting with another SN, for example, the SN1 308, the SN2 310, and/or the SN3 312. Additionally, or alternatively, the MN 304 may also indicate to the SN0 306 that the K_{SN} transmitted by the MN 304 to the SN0 306 at 354 is not to be used during the current connection between the SN0 306 and the UE 302, but for the subsequence future connection.

In some embodiments, and by way of a non-limiting example, upon receiving RRC connection reconfiguration complete from the UE, the MN may update K_{SN} for an SN to which the UE is currently connected in a DC mode, and transmit the updated K_{SN} to the SN such that the SN has an up-to-date security configuration for establishing a secure connection.

In some embodiments, and by way of a non-limiting example, the UE may not delete the security configuration associated with any of the candidate SNs, but may update a K_{SN}-Counter of a particular SN using a K_{SN}-Offset of the particular SN upon establishing a DC mode with the particular SN. However, the UE may delete the security configuration, e.g., the K_{SN}-Counter and/or K_{SN}-Offset, when the UE is handover to a different PCell or MN. The UE may also delete the security configuration when there is a radio link failure at the PCell or MN. In some embodiments, and by way of a non-limiting example, the UE may not delete a security configuration received from a PCell until re-establishment, and delete the security configuration when the new security configuration received from the PCell is different from the previously received security configuration.

In some embodiments, and by way of a non-limiting example, a UE may delete the security configuration associated with a particular SN or PSCell which is failed. In some cases, a UE may delete a security configuration associated with all candidate SNs or PSCells when there is a failure at any of the candidate SNs.

In some embodiments, and by way of a non-limiting example, the security configuration associated with each SN may have a different value for a K_{SN}-Counter and/or a K_{SN}-Offset. An example message structure for transmitting security configuration associated with each candidate SN using RRC signaling may be as follows:

```
RRCReconfiguration-v1560-IEs ::= SEQUENCE {
  mrdc-SecondaryCellGroupConfig CHOICE {
    release NULL,
    setup MRDC-SecondaryCellGroupConfig
  } OPTIONAL, -- Need M
```

| | |
|---|---|
| radioBearerConfig2 | OCTET STRING { CONTAINING RadioBearerConfig) |

OPTIONAL, -- Need M
sk-counter sk-Counter OPTIONAL, -- Need N

| | |
|---|---|
| nonCriticalExtension | RRCReconfiguration-v1800-IEs OPTIONAL |
| } | |

RRCReconfiguration-v1800-Ies ::= SEQUENCE {

| | |
|---|---|
| SCG-ToAddModList | SEQUENCE (SIZE(1 ... maxNrofSCGs)) OF MRDC- |

SecondaryCellGroupConfig-r18 OPTIONAL, -- Need N

| | |
|---|---|
| SCG-ToReleaseList | SEQUENCE (SIZE(1 ... maxNrofSCGs)) OF SCG- |

Identity OPTIONAL, -- Need N

}

MRDC-SecondaryCellGroupConfig-r18 ::= SEQUENCE {

| | |
|---|---|
| scg-Identity SCG-Identity, | |
| mrdc-SecondaryCellGroup | SEQUENCE { |
| nr-SCG | OCTET STRING (CONTAINING RRCReconfiguration), |
| sk-Counter | SK-Counter OPTIONAL, -- Need M |
| sk-Counter-Offset | SK-CounterOffset OPTIONAL, -- Need N |
| } | |
| } | |

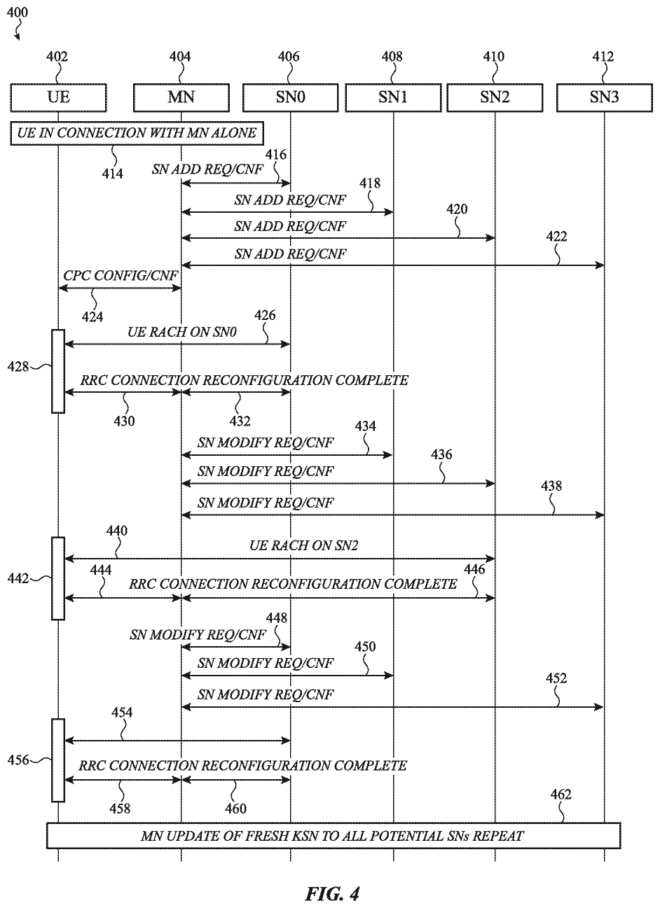

In some embodiments, and by way of a non-limiting example, at steps 344, and/or 354, an MN may update the security configuration associated with other SNs to which a UE is not connected as a result of a CPC mechanism, which is illustrated in a message flow shown in FIG. 4. In other words, the MN 304, at 344, may update the security configuration associated with the SNs 306, 308, and 312, and at 354, may update the security configuration associated with the SNs 308, 310, and 312. Similarly, at 338, the UE may update the security configuration associated with the SNs 306, 308, and 312 by updating their respective K_{SN}-Counter using their respective K_{SN}-Offset. In other words, at 338, the UE may not update the security configuration associated with the SN2 310 to which the UE 302 is currently connected using the CPC mechanism. At 348, the UE 302 may update security configuration associated with the SNs 308, 310, and 312 by updating their respective K_{SN}-Counter using their respective K_{SN}-Offset. In other words, at 348, the UE may not update the security configuration associated with the SN0 306 to which the UE 302 is currently connected using the CPC mechanism.

FIG. 4 illustrates another example message flow of a CG change mechanism, according to embodiments described herein. As shown in FIG. 4, a message flow 400 illustrates messages exchanged between a UE 402, an MN 404, and two or more SNs, for example, an SN0 406, an SN1 408, an SN2 410, and an SN3 412. As shown in the message flow 400 as 414, the UE 402 is connected with the MN 404 alone. The MN 404 may determine or identify candidate SNs, for example, the SN0 406, the SN1 408, the SN2 410, and the SN3 412, and may transmit a configuration and request corresponding to establishing a secure connection with the UE 402, as shown in FIG. 4 as 416, 418, 420, and 422, respectively. The configuration transmitted by the MN 404 to each of the SN0 406, the SN1 408, the SN2 410, and the SN3 412 may include a respective K_{SN} for each of the SN0 406, the SN1 408, the SN2 410, and the SN3 412. The respective K_{SN} for each of the SN0 406, the SN1 408, the SN2 410, and the SN3 412 may be generated by the MN 404, as described herein, in accordance with some embodiments.

The MN 404 may also transmit a security configuration to the UE 402 that is shown in FIG. 4 as 424. The security configuration transmitted by the MN 404 to the UE 402 at 424 may include a K_{SN}-Counter corresponding to each candidate SN, and a K_{SN}-Offset corresponding to each candidate SN. The UE may use the received K_{SN}-Counter and/or K_{SN}-Offset associated with an SN, for which one or more radio conditions specified by the MN 404 may be satisfied at the UE 402, to derive a K_{SN} for establishing a secure connection with the SN.

In some embodiments, and by way of a non-limiting example, the UE 402 may be configured, for example, by the MN 404, to derive a K_{SN} for an SN using a K_{SN}-Counter, and once the UE establishes a DC mode with an SN, the UE may update the K_{SN}-Counter using a K_{SN}-Offset. The UE 402 may then use the updated K_{SN}-Counter for a subsequent connection with the SN when the UE connects to the same SN after being connected with another SN, such that the UE may use a different K_{SN}-Counter while connecting with the same SN again.

In some embodiments, and by way of a non-limiting example, the UE 402 may be configured, for example, by the MN 404, to derive a K_{SN} for an SN using a K_{SN}-Counter and a K_{SN}-Offset before the UE establishes a DC mode with an SN. Accordingly, the UE may generate a unique K_{SN} for the SN each time the UE is connecting with the same SN.

As shown in FIG. 4, at 428, the UE 402 may determine that one or more radio conditions as specified by the MN 404 for connecting with an SN or an SN change are satisfied with respect to the SN0 406. The UE 402 may, therefore, perform a RACH procedure 426 to connect with the SN0 406, or to establish a DC mode with the MN 404 and the SN0 406. The UE 402 may transmit RRC connection reconfiguration complete 430 to the MN 404 to inform the MN 404 that the UE is now connected with the SN0 406, and the MN 404 may transmit RRC connection reconfiguration complete 432 to the SN0 406.

As described herein, in accordance with some embodiments, after establishing a DC mode with the SN0 406 and the MN 404, the UE 402 may update the K_{SN}-Counter associated with the SN1 408, the SN2 410, and/or the SN3 412, using their respective K_{SN}-Offset and K_{SN}-Counter. As shown in FIG. 4 as 434, 436, and 438, the MN 304 may regenerate a respective K_{SN} for each of the SN1 408, the SN2 410, and/or the SN3 412, based on their respective K_{SN}-Offset and K_{SN}-Counter, and transmit to the SN1 408, the SN2 410, and/or the SN3 412 their respective regenerated K_{SN}.

As shown in FIG. 4, at 442, the UE 402 may determine that one or more radio conditions, as specified by the MN 404, for connecting with an SN or a CPC procedure are satisfied with respect to the SN2 410. The UE 402 may, therefore, perform a RACH procedure 440 to connect with the SN2 410, or to establish a DC mode with the MN 404 and the SN2 410. The UE 402 may transmit RRC connection reconfiguration complete 444 to the MN 404 to inform the MN 404 that the UE is now connected with the SN2 410, and the MN 404 may transmit RRC connection reconfiguration complete 446 to the SN2 410.

The UE 402 may use the received K_{SN}-Counter and/or K_{SN}-Offset associated with the SN2 410 to derive a K_{SN} for establishing a secure connection with the SN2 410. As described herein, in some embodiments, and by way of a non-limiting example, the UE 402 may derive a K_{SN} associated with the SN2 410 using a K_{SN}-Counter associated with the SN2 410, and once the UE 402 establishes a DC mode with the SN2 410, the UE 402 may update the K_{SN}-Counter using K_{SN}-Offset associated with the SN2 410, and then use the updated K_{SN}-Counter for a subsequent connection with the SN2 410 when the UE 402 connects to the SN2 410 after being connected with another SN, for example, the SN0 406, the SN1 408, and/or the SN3 412. Accordingly, the UE 402 may use a different K_{SN}-Counter while connecting with the SN2 410.

In some embodiments, and by way of a non-limiting example, the UE 402 may be configured, for example, by the MN 404, to derive a K_{SN} for establishing a secure connection with the SN2 410 using the K_{SN}-Counter and K_{SN}-Offset associated with the SN2 410 before the UE establishes a DC mode with the SN2 410. Accordingly, the UE 402 may generate a unique K_{SN} for the SN2 410 each time the UE 402 is connecting with the SN2 410.

As described herein, in accordance with some embodiments, after establishing a DC mode with the SN2 410 and the MN 404, the UE 402 may update the K_{SN}-Counter associated with the SN1 408, the SN0 406, and/or the SN3 412, using their respective K_{SN}-Offset and K_{SN}-Counter. As shown in FIG. 4 as 448, 450, and 452, the MN 404 may regenerate a respective K_{SN} for each of the SN1 408, the SN0 406, and/or the SN3 412, based on their respective K_{SN}-Offset and K_{SN}-Counter, and transmit to the SN1 408, the SN0 406, and/or the SN3 412, their respective regenerated K_{SN}.

As shown in FIG. 4, at 456, the UE 402 may determine that one or more radio conditions as specified by the MN 404 for connecting with the SN0 406 are satisfied. The UE 402 may, therefore, perform a RACH procedure 454 to connect with the SN0 406, or to establish a DC mode with the MN 404 and the SN0 406. The UE 402 may transmit RRC connection reconfiguration complete 458 to the MN 404 to inform the MN 404 that the UE 402 is now connected with the SN0 406, and the MN 404 may transmit RRC connection reconfiguration complete 460 to the SN0 406.

At 462, the MN 404 may repeat operations performed at 448, 450, and 452, but this time 448 is performed with respect to the SN2 410.

In some embodiments, and by way of a non-limiting example, the UE may not delete the security configuration associated with any of the candidate SNs, but may update a K_{SN}-Counter of a particular SN using a K_{SN}-Offset of the particular SN upon establishing a DC mode with the particular SN. However, the UE may delete the security configuration, e.g., the K_{SN}-Counter and/or K_{SN}-Offset, when the UE is handover to a different PCell or MN. The UE may also delete the security configuration when there is a radio link failure at the PCell or MN. In some embodiments, and by way of a non-limiting example, the UE may not delete the security configuration received from a PCell until re-establishment, and delete the security configuration when the new security configuration received from the PCell is different from the previously received security configuration.

In some embodiments, and by way of a non-limiting example, a UE may delete the security configuration associated with a particular SN or PSCell which is failed. In some cases, a UE may delete the security configuration associated with all candidate SNs or PSCells when there is a failure at any of the candidate SNs.

In some embodiments, and by way of a non-limiting example, the security configuration associated with each SN may have a different value for a K_{SN}-Counter and/or a K_{SN}-Offset, and also indicate whether the UE has to update the security configuration for the SN to which the UE is attached now using a CPC mechanism, or other SNs to which the UE is not currently attached as a result of the CPC mechanism. An example message structure for transmitting the security configuration, associated with each candidate SN, and indicating a particular way in which the UE needs to update the security configuration associated with one or more SNs, using RRC signaling may be as follows:

```
RRCReconfiguration-v1560-IEs ::= SEQUENCE {
  mrdc-SecondaryCellGroupConfig CHOICE {
    release NULL,
    setup MRDC-SecondaryCellGroupConfigg
  } OPTIONAL, -- Need M
```

| | |
|---|---|
| radioBearerConfig2 | OCTET STRING { CONTAINING RadioBearerConfig) |

OPTIONAL, -- Need M
sk-counter SK-Counter OPTIONAL, -- Need M

| | |
|---|---|
| nonCriticalExtension | RRCReconfiguration-v1800-IEs OPTIONAL |
| } | |

RRCReconfiguration-v1800-Ies ::= SEQUENCE {

| | |
|---|---|
| SCG-ToAddModList | SEQUENCE (SIZE(1 ... maxNrofSCGs)) OF MRDC- |

SecondaryCellGroupConfig-r18 OPTIONAL, -- Need N

| | |
|---|---|
| SCG-ToReleaseList | SEQUENCE (SIZE(1 ... maxNrofSCGs)) OF SCG- |
| Identity OPTIONAL, -- Need N | |
| updateOther-SCGs | ENUMERATED {true} OPTIONAL - Need M |
| } | |

MRDC-SecondaryCellGroupConfig-r18 ::= SEQUENCE {

| | |
|---|---|
| scg-Identity SCG-Identity, | |
| mrdc-SecondaryCellGroup | SEQUENCE { |
| nr-SCG | OCTET STRING (CONTAINING RRCReconfiguration), |
| sk-Counter | SK-Counter OPTIONAL, -- Need M |
| sk-Counter-Offset | SK-counterOffset OPTIONAL, -- Need N |
| } | |
| } | |

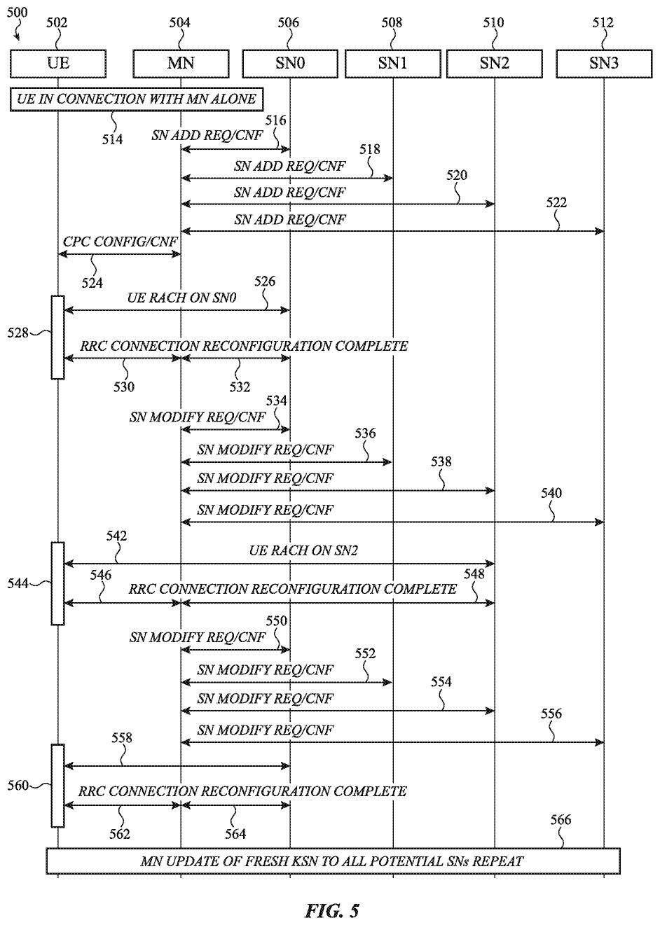

As shown in FIG. 4, an MN provides an updated security configuration to all candidate SNs except an SN to which a UE is currently connected in a DC mode. However, in some embodiments, the MN may provide an updated security configuration to all candidate SNs including the SN to which the UE is currently connected in a DC mode, as illustrated in a message flow shown in FIG. 5.

FIG. 5 illustrates another example message flow of a CG change mechanism, according to embodiments described herein. As shown in FIG. 5, a message flow 500 illustrates messages exchanged between a UE 502, an MN 504, and two or more SNs, for example, an SN0 506, an SN1 508, an SN2 510, and an SN3 512. As shown in the message flow 500 as 514, the UE 502 is connected with the MN 504 only. The MN 504 may determine or identify candidate SNs, for example, the SN0 506, the SN1 508, the SN2 510, and the SN3 512, and may transmit a configuration and request corresponding to establishing a secure connection with the UE 502, which is shown in FIG. 5 as 516, 518, 520, and 522, respectively. The configuration transmitted by the MN 504 to each of the SN0 506, the SN1 508, the SN2 510, and the SN3 512 may include a respective K_{SN} for each of the SN0 506, the SN1 508, the SN2 510, and the SN3 512.

The MN 504 may also transmit the security configuration to the UE 502 that is shown in FIG. 5 as 524. The security configuration transmitted by the MN 504 to the UE 502 at 524 may include a secondary node key counter (K_{SN}-Counter) corresponding to each candidate SN, and a secondary node key offset (K_{SN}-Offset) corresponding to each candidate SN. The UE may use the received K_{SN}-Counter and/or K_{SN}-Offset associated with an SN, for which one or more radio conditions specified by the MN 504 may be satisfied at the UE 502, to derive a K_{SN} for establishing a secure connection with the SN.

In some embodiments, and by way of a non-limiting example, the UE 502 may be configured, for example, by the MN 504, to derive a K_{SN} for an SN using a K_{SN}-Counter, and once the UE establishes a DC mode with an SN, the UE may update the K_{SN}-Counter using K_{SN}-Offset, and then the updated K_{SN}-Counter may be used for a subsequent future connection with the SN. Accordingly, the UE may use a different K_{SN}-Counter while connecting with the same SN again.

In some embodiments, and by way of a non-limiting example, the UE 502 may be configured, for example, by the MN 504, to derive a K_{SN} for an SN using a K_{SN}-Counter that is updated based on a K_{SN}-Offset before the UE establishes a DC mode with a SN. Accordingly, the UE may generate a unique K_{SN} for the SN each time the UE is connecting with the same SN.

As shown in FIG. 5, at 528, the UE 502 may determine that one or more radio conditions as specified by the MN 504 for connecting with an SN or a CPC procedure are satisfied with respect to the SN0 506. The UE 502 may, therefore, perform a RACH procedure 526 to connect with the SN0 506, or to establish a DC mode with the MN 504 and the SN0 506. The UE 502 may transmit RRC connection reconfiguration complete 530 to the MN 504 to inform the MN 504 that the UE is now connected with the SN0 506, and the MN 504 may transmit RRC connection reconfiguration complete 532 to the SN0 506.

As described herein, in accordance with some embodiments, after establishing a DC with the SN0 506 and the MN 504, the UE 502 may update the K_{SN}-Counter associated with each candidate SN, including the SN0 506, the SN1 508, the SN2 510, and/or the SN3 512, using their respective K_{SN}-Offset and K_{SN}-Counter, for a future connection with any of the candidate SNs.

As shown in FIG. 5 as 534, 536, 538, and 540, the MN 504 may regenerate a respective K_{SN} for each of the SN0 506, the SN1 508, the SN2 510, and/or the SN3 512, based on their respective K_{SN}-Offset and K_{SN}-Counter, and transmit to the SN0 506, the SN1 508, the SN2 510, and/or the SN3 512 their respective regenerated K_{SN}.

As shown in FIG. 5, at 544, the UE 502 may determine that one or more radio conditions, as specified by the MN 504, for connecting with an SN or a CPC procedure are satisfied with respect to the SN2 510. The UE 502 may, therefore, perform a RACH procedure 542 to connect with the SN2 510, or to establish a DC mode with the MN 504 and the SN2 510. The UE 502 may transmit RRC connection reconfiguration complete 546 to the MN 504 to inform the MN 504 that the UE is now connected with the SN2 510, and the MN 504 may transmit RRC connection reconfiguration complete 548 to the SN2 510.

The UE 502 may use the received K_{SN}-Counter and/or K_{SN}-Offset associated with the SN2 510 to derive a K_{SN} for establishing a secure connection with the SN2 510. Once the UE 502 establishes a DC with the SN2 510, the UE 502 may update the K_{SN}-Counter using a K_{SN}-Offset associated with the SN2 510, and then use the updated K_{SN}-Counter for a subsequent connection with the SN2 510 when the UE 502 connects to the SN2 510 after being connected with another SN, for example, the SN0 506, the SN1 508, and/or the SN3 512. Accordingly, the UE 502 may use a different K_{SN}-Counter while connecting with the SN2 510.

As described herein, in accordance with some embodiments, after establishing a DC with the SN2 510 and the MN 504, the UE 502 may update the K_{SN}-Counter associated with the SN1 508, the SN0 506, and/or the SN3 512, using their respective K_{SN}-Offset and K_{SN}-Counter. As shown in FIG. 5 as 550, 552, 554, and 556, the MN 504 may regenerate a respective K_{SN} for each of the SN0 506, the SN1 508, the SN2 510, and/or the SN3 512, based on their respective K_{SN}-Offset and K_{SN}-Counter, and transmit to the SN0 506, the SN1 508, the SN2 510, and/or the SN3 512, their respective regenerated K_{SN}.

As shown in FIG. 5, at 560, the UE 502 may determine that one or more radio conditions as specified by the MN 504 for connecting with the SN0 506 are satisfied. The UE 502 may, therefore, perform a RACH procedure 558 to connect with the SN0 506, or to establish a DC mode with the MN 504 and the SN0 506. The UE 502 may transmit RRC connection reconfiguration complete 562 to the MN 504 to inform the MN 504 that the UE is now connected with the SN0 506, and the MN 504 may transmit RRC connection reconfiguration complete 564 to the SN0 506.

At 566, the MN 504 may repeat operations performed at 550, 552, 554, and 556, and the UE 502 may also update a K_{SN}-Counter for each candidate SN based on a respective K_{SN}-Offset, as described herein, in accordance with some embodiments.

In some embodiments, and by way of a non-limiting example, the UE may not delete the security configuration associated with any of the candidate SNs, but may update a K_{SN}-Counter of a particular SN using a K_{SN}-Offset of the particular SN upon establishing a DC mode with the particular SN. However, the UE may delete the security configuration, e.g., the K_{SN}-Counter and/or K_{SN}-Offset, when the UE is handover to a different PCell or MN. The UE may also delete the security configuration when there is a radio link failure at the PCell or MN. In some embodiments, and by way of a non-limiting example, the UE may not delete the security configuration received from a PCell until re-establishment, and delete the security configuration when the new security configuration received from the PCell is different from the previously received security configuration.

In some embodiments, and by way of a non-limiting example, a UE may delete the security configuration associated with a particular SN or PSCell which failed. In some cases, a UE may delete the security configuration associated with all candidate SNs or PSCells when there is a failure at any of the candidate SNs.

In some embodiments, and by way of a non-limiting example, the security configuration associated with each SN may have a different value for a K_{SN}-Counter and/or a K_{SN}-Offset, and also indicate whether the UE has to update the security configuration for the SN to which the UE is attached now using a CPC mechanism, or other SNs to which the UE is not currently attached as a result of the CPC mechanism. An example message structure for transmitting a security configuration, associated with each candidate SN, and indicating a particular way in which the UE needs to update the security configuration associated each candidate SN, using RRC signaling may be as follows:

```
RRCReconfiguration-v1560-IEs ::= SEQUENCE {
  mrdc-SecondaryCellGroupConfig CHOICE {
    release NULL,
    setup MRDC-SecondaryCellGroupConfigg
  } OPTIONAL, -- Need M
```

| | |
|---|---|
| radioBearerConfig2 | OCTET STRING { CONTAINING RadioBearerConfig) |

OPTIONAL, -- Need M
sk-counter SK-Counter OPTIONAL, -- Need M

| | |
|---|---|
| nonCriticalExtension | RRCReconfiguration-v1800-IEs OPTIONAL |
| } | |

RRCReconfiguration-v1800-Ies ::= SEQUENCE {

| | |
|---|---|
| SCG-ToAddModList | SEQUENCE (SIZE(1 ... maxNrofSCGs)) OF MRDC- |

SecondaryCellGroupConfig-r18 OPTIONAL, -- Need N

| | |
|---|---|
| SCG-ToReleaseList | SEQUENCE (SIZE(1 ... maxNrofSCGs)) OF SCG- |
| Identity OPTIONAL, -- Need N | |
| update-SCGs | ENUMERATED {true} OPTIONAL - Need M |
| } | |

MRDC-SecondaryCellGroupConfig-r18 ::= SEQUENCE {

| | |
|---|---|
| scg-Identity SCG-Identity, | |
| mrdc-SecondaryCellGroup | SEQUENCE { |
| nr-SCG | OCTET STRING (CONTAINING RRCReconfiguration), |
| sk-Counter | SK-Counter OPTIONAL, -- Need M |
| sk-Counter-Offset | SK-counterOffset OPTIONAL, -- Need N |
| } | |
| } | |

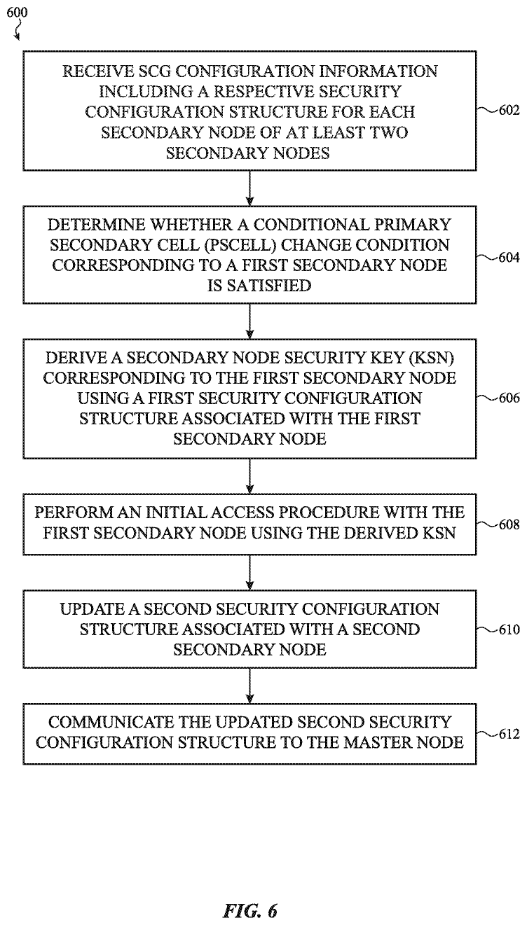

FIG. 4, FIG. 5, and FIG. 6 thus illustrate message flows corresponding to five different embodiments in which the CPC mechanism can be performed by a UE without an additional RRC signaling with the UE. As a precondition for each of these four embodiments, an MN may generate a respective K_{SN} using a K_{SN}-Counter and a K_{SN}-Offset associated with each candidate SN, as described herein, in accordance with some embodiments, and provide the respective K_{SN} to each candidate SN of the UE. The MN may also provide the K_{SN}-Counter and the K_{SN}-Offset configuration associated with each candidate SN to the UE.

In a first embodiment, upon one or more radio conditions being satisfied at a UE with respect to one of the candidate SNs, the UE may trigger a CPC mechanism, and derive a K_{SN} corresponding to the one of the candidate SNs using a respective K_{SN}-Counter. After the CPC mechanism is completed, the UE may then update the K_{SN}-Counter corresponding to the one of the candidate SNs to which the UE is now connected using the respective K_{SN}-Offset. In one example, the K_{SN}-Counter may be incremented by the K_{SN}-Offset. In another example, a different formula may be used to update the K_{SN}-Counter based on the K_{SN}-Offset. The MN may provide the updated security configuration to the SN to which the UE is now currently in a DC mode after the CPC mechanism is triggered at the UE.

In a second embodiment, upon one or more radio conditions being satisfied at a UE with respect to one of the candidate SNs, the UE may trigger a CPC mechanism, and derive a K_{SN} corresponding to the one of the candidate SNs using a respective K_{SN}-Counter and K_{SN}-Offset. In one example, the K_{SN}-Counter may be incremented by the K_{SN}-Offset. In another example, a different formula may be used to update the K_{SN}-Counter based on the K_{SN}-Offset. After the CPC mechanism is completed, the MN may generate the updated security configuration by updating the K_{SN}-Counter based on the K_{SN}-Offset, and provide the updated security configuration to the SN with the UE now currently in a DC mode after the CPC mechanism is triggered at the UE. The MN may also indicate to the SN that the updated security configuration is for the future connection with the UE, and not the current connection with the UE.

In a third embodiment, upon one or more radio conditions being satisfied at a UE with respect to one of the candidate SNs, the UE may trigger a CPC mechanism, and derive a K_{SN} corresponding to the one of the candidate SNs using a respective K_{SN}-Counter. After the CPC mechanism is completed, the UE may then update the K_{SN}-Counter corresponding to the candidate SNs with whom the UE is not currently connected using their respective K_{SN}-Offset. In one example, the K_{SN}-Counter may be incremented by the K_{SN}-Offset. In another example, a different formula may be used to update the K_{SN}-Counter based on the K_{SN}-Offset. The MN may provide the updated security configuration to the candidate SNs with whom the UE is not currently connected in a DC mode after the CPC mechanism is triggered at the UE.

In a fourth embodiment, upon one or more radio conditions being satisfied at a UE with respect to one of the candidate SNs, the UE may trigger a CPC mechanism, and derive a K_{SN} corresponding to the one of the candidate SNs using a respective K_{SN}-Counter and K_{SN}-Offset. In one example, the K_{SN}-Counter may be incremented by the K_{SN}-Offset. In another example, a different formula may be used to update the K_{SN}-Counter based on the K_{SN}-Offset. After the CPC mechanism is completed, the UE may update the K_{SN}-Counter corresponding to the candidate SNs with whom the UE is not currently connected using their respective K_{SN}-Offset, and the MN may provide the updated security configuration to the SNs when the UE is not currently connected in a DC mode after the CPC mechanism is triggered at the UE.

In a fifth embodiment, upon one or more radio conditions being satisfied at a UE with respect to one of the candidate SNs, the UE may trigger a CPC mechanism, and derive a K_{SN} corresponding to the one of the candidate SNs using a respective K_{SN}-Counter. After the CPC mechanism is completed, in one example, the UE may update the K_{SN}-Counter for each candidate SN by incrementing it with the respective K_{SN}-Offset. In other example, a different formula may be used to update the K_{SN}-Counter based on the K_{SN}-Offset. The MN may similarly update the security configuration corresponding to each of the candidate SNs and provide the updated security configuration to each of the candidate SNs.

FIG. 6 illustrates an example flow-chart of operations being performed by a UE, according to embodiments described herein. As shown in a flow-chart 600, at 602, a UE may receive, from an MN, SCG configuration information for each of at least two SNs. As described herein, in accordance with some embodiments, a UE may be configured to operate in a DC mode having a connection with an MN and a connection with an SN. The UE may have more than one SNs to which the UE may connect to, based on one or more radio conditions as they are satisfied at the UE. Accordingly, the SCG configuration information may include information about one or more radio conditions that need to be satisfied for triggering a CPC procedure, as described herein, in accordance with some embodiments. The SCG configuration information associated with each candidate SN (at least two SNs) may include a security configuration structure corresponding to each candidate SN.

As described herein, in some embodiments, and by way of a non-limiting example, the security configuration structure may include a K_{SN}-Counter and a K_{SN}-Offset associated with each candidate SN. The security configuration structure may also indicate whether the UE needs to update a security associated with the SN to which the UE is currently connected following the CPC procedure, for other candidate SNs with whom the UE is not currently connected following the CPC procedure, or all candidate SNs. The K_{SN}-Counter and/or the K_{SN}-Offset associated with each candidate SN may be used to derive a K_{SN} corresponding to each candidate SN to establish a secure bearer connection with the SN.

At 604, the UE may determine whether one or more radio conditions are satisfied with respect to an SN of the candidate SNs to trigger a CPC procedure. For example, there may be a first SN and a second SN in addition to an MN. The UE may be connected with the MN, and the UE may determine, at 604, that the one or more radio conditions for the UE to trigger the CPC procedure to connect with the first SN are met.

At 606, the UE may derive a K_{SN} corresponding to the first SN using a security configuration structure associated with the first SN (e.g., a first security configuration structure). As described herein, in accordance with some embodiments, the K_{SN} corresponding to the first SN may be derived using the K_{SN}-Counter alone. In some embodiments, and by way of a non-limiting example, the K_{SN} corresponding to the first SN may be derived by updating the K_{SN}-Counter based on the corresponding K_{SN}-Offset.

At 608, the UE may perform a RACH procedure (or an initial access procedure) to connect with the first SN. The UE may thus have a DC with the first SN and the MN. The UE may use the derived K_{SN} corresponding to the first SN to establish a secure connection with the first SN.

At 610, the UE may update a security configuration structure associated with the second SN (e.g., a second security configuration structure), as described herein, in accordance with some embodiments. By way of a non-limiting example, the UE may update a K_{SN}-Counter of the second security configuration structure by adding a K_{SN}-Offset of the second security configuration structure, or the UE may update a K_{SN}-Counter of the second security configuration structure based on a K_{SN}-Offset of the second security configuration structure using any other formula.

At 612, the UE may communicate the updated security configuration structure associated with the second SN to the MN. By way of a non-limiting example, the UE may communicate an updated K_{SN}-Counter to the MN, so that the MN may communicate an updated K_{SN} to the second SN. As a result, the second SN may have a correct K_{SN} to establish a secure connection with the UE in the future.

Additionally, or alternatively, the UE may save the updated second security configuration structure and the first security configuration structure instead of deleting or removing them from its memory, and thereby eliminating a need of reconfiguring the UE with the SCG configuration again using RRC signaling after performing a CPC procedure.

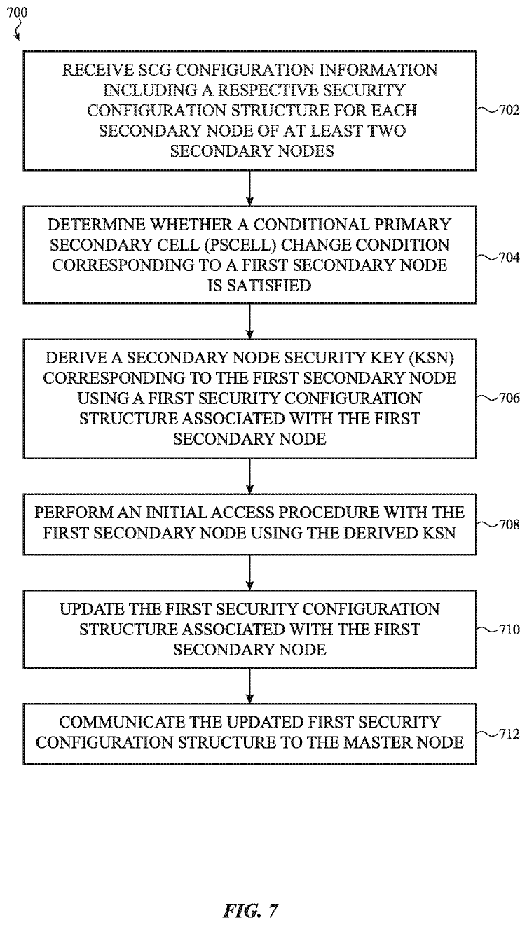

FIG. 7 illustrates another example flow-chart of operations being performed by a UE, according to embodiments described herein. As shown in a flow-chart 700, at 702, a UE may receive, from an MN, SCG configuration information for each of at least two SNs. As described herein, in accordance with some embodiments, a UE may be configured to operate in a DC mode having a connection with an MN and a connection with an SN. The UE may have more than one SNs to which the UE may connect to, based on one or more radio conditions as they are satisfied at the UE. Accordingly, the SCG configuration information may include information about one or more radio conditions that need to be satisfied for triggering a CPC procedure, as described herein, in accordance with some embodiments. The SCG configuration information associated with each candidate SN (at least two SNs) may include a security configuration structure corresponding to each candidate SN.

As described herein, in some embodiments, and by way of a non-limiting example, the security configuration structure may include a K_{SN}-Counter and a K_{SN}-Offset associated with each candidate SN. The security configuration structure may also indicate whether the UE needs to update a security associated with the SN to which the UE is currently connected following the CPC procedure, for other candidate SNs with whom the UE is not currently connected following the CPC procedure, or all candidate SNs. The K_{SN}-Counter and/or the K_{SN}-Offset associated with each candidate SN may be used to derive a K_{SN} corresponding to each candidate SN to establish a secure bearer connection with the SN.

At 704, the UE may determine whether one or more radio conditions are satisfied with respect to an SN of the candidate SNs to trigger a CPC procedure. For example, there may be a first SN and a second SN in addition to an MN. The UE may be connected with the MN, and the UE may determine, at 704, that the one or more radio conditions for the UE to trigger the CPC procedure to connect with the first SN are met.

At 706, the UE may derive a K_{SN} corresponding to the first SN using a security configuration structure associated with the first SN (e.g., a first security configuration structure). As described herein, in accordance with some embodiments, the K_{SN} corresponding to the first SN may be derived using the K_{SN}-Counter alone. In some embodiments, and by way of a non-limiting example, the K_{SN} corresponding to the first SN may be derived by updating the K_{SN}-Counter based on the corresponding K_{SN}-Offset.

At 708, the UE may perform a RACH procedure (or an initial access procedure) to connect with the first SN. The UE may thus have a DC mode with the first SN and the MN. The UE may use the derived K_{SN} corresponding to the first SN to establish a secure connection with the first SN.

At 710, the UE may update a security configuration structure associated with the first SN (e.g., the first security configuration structure), as described herein, in accordance with some embodiments. By way of a non-limiting example, the UE may update a K_{SN}-Counter of the first security configuration structure by adding a K_{SN}-Offset of the first security configuration structure, or the UE may update a K_{SN}-Counter of the first security configuration structure based on a K_{SN}-Offset of the first security configuration structure using any other formula.

At 712, the UE may communicate the updated security configuration structure associated with the first SN to the MN. By way of a non-limiting example, the UE may communicate an updated K_{SN}-Counter to the MN, so that the MN may communicate an updated K_{SN} to the first SN. As a result, the first SN may have a correct K_{SN} to establish a secure connection with the UE in the future.

Additionally, or alternatively, the UE may save the updated first security configuration structure and the second security configuration structure instead of deleting or removing them from its memory, and thereby eliminating a need of reconfiguring the UE with the SCG configuration again using RRC signaling after performing a CPC procedure.

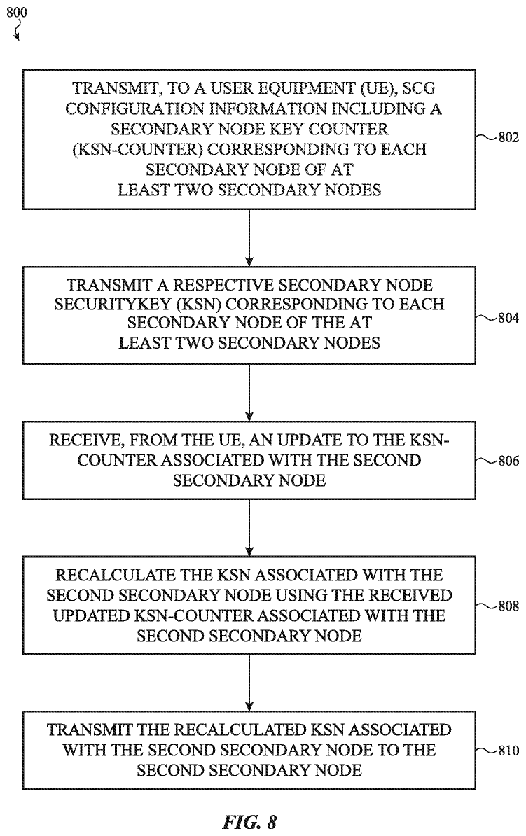

FIG. 8 illustrates an example flow-chart of operations being performed by a base station, according to embodiments described herein. As shown in a flow-chart 800, at 802, a base station (or an MN) may transmit, to a UE, SCG configuration information for each of at least two candidate SNs. As described herein, in accordance with some embodiments, a UE may be configured to operate in a DC mode having a connection with an MN and a connection with an SN. The UE may have more than one SN to which the UE may connect to, based on one or more radio conditions as they are satisfied at the UE. Accordingly, the SCG configuration information may include information about one or more radio conditions that need to be satisfied for triggering a CPC procedure, as described herein, in accordance with some embodiments. The SCG configuration information associated with each candidate SN (at least two SNs) may include a security configuration structure corresponding to each candidate SN.

As described herein, in some embodiments, and by way of a non-limiting example, the security configuration structure may include a K_{SN}-Counter and/or a K_{SN}-Offset associated with each candidate SN. The security configuration structure may also indicate whether the UE needs to update a security associated with the SN to which the UE is currently connected following the CPC procedure, for other candidate SNs with whom the UE is not currently connected following the CPC procedure, or all candidate SNs. The K_{SN}-Counter and/or the K_{SN}-Offset associated with each candidate SN may be used to derive a K_{SN} corresponding to each candidate SN to establish a secure bearer connection with the SN.

At 804, the MN may also transmit to each candidate SN a K_{SN} corresponding to each candidate SN, where the K_{SN} corresponding to each candidate SN may be derived using their respective K_{SN}-Counter and/or K_{SN}-Offset.

At 806, the MN may receive, from the UE, an updated K_{SN}-Counter for one or more SNs. By way of a non-limiting example, the UE connected with the MN and a first SN may transmit an updated K_{SN}-Counter for a second SN following a CPC procedure to have a DC mode with the MN and the second SN. Accordingly, the MN may receive from the UE the updated K_{SN}-Counter for the second SN. In some cases, as described herein, in accordance with some embodiments, the MN may receive the updated K_{SN}-Counter for the first SN or all candidate SNs following a CPC procedure to have a DC mode with the MN and the second SN.

At 808, the MN may recalculate the K_{SN} corresponding to one or more candidate SNs for which the MN has received an updated K_{SN}-Counter at 806, and transmit the recalculated K_{SN} corresponding to the one or more candidate SNs to the respective one or more candidate SNs at 810. Accordingly, the MN may not be required to reconfigure the UE with an SCG configuration following execution of a CPC procedure by the UE.

In some embodiments, and by way of a non-limiting example, the MN may transmit to each candidate SN a security configuration structure including a K_{SN}-Counter and a K_{SN}-Offset. The MN may also indicate to each candidate SN how to derive a K_{SN} using a K_{SN}-Counter and/or a K_{SN}-Offset to establish a secure connection with the UE, following execution of a CPC procedure by the UE with respect to any of the candidate SNs. A candidate SN may update its respective K_{SN} when a UE connected with an SN is no longer connected with the SN following execution of a CPC procedure.

Embodiments contemplated herein include an apparatus having means to perform one or more elements of the method 600, 700, or 800, and/or message flows 300, 400, or 500. In the context of method 600 or 700, and/or message flows 300, 400, or 500, this apparatus may be, for example, an apparatus of a UE (such as a wireless device 1002 that is a UE, as described herein). In the context of method 800, and/or message flows 300, 400, or 500, this apparatus may be, for example, an apparatus of a base station (such as a network device 1020 that is a base station, as described herein).

Embodiments contemplated herein include one or more non-transitory computer-readable media storing instructions to cause an electronic device, upon execution of the instructions by one or more processors of the electronic device, to perform one or more elements of the method 600, 700, or 800, and/or message flows 300, 400, or 500. In the context of method 600 or 700, and/or message flows 300, 400, or 500, this non-transitory computer-readable media may be, for example, a memory of a UE (such as a memory 1006 of a wireless device 1002 that is a UE, as described herein). In the context of method 800, and/or message flows 300, 400, or 500, this non-transitory computer-readable media may be, for example, a memory of a base station (such as a memory 1024 of a network device 1020 that is a base station, as described herein).

Embodiments contemplated herein include an apparatus having logic, modules, or circuitry to perform one or more elements of the method 600, 700, or 800, and/or message flows 300, 400, or 500. In the context of method 600 or 700, and/or message flows 300, 400, or 500, this apparatus may be, for example, an apparatus of a UE (such as a wireless device 1002 that is a UE, as described herein). In the context of method 800, and/or message flows 300, 400, or 500, this apparatus may be, for example, an apparatus of a base station (such as a network device 1020 that is a base station, as described herein).

Embodiments contemplated herein include an apparatus having one or more processors and one or more computer-readable media, using or storing instructions that, when executed by the one or more processors, cause the one or more processors to perform one or more elements of the method 600, 700, or 800, and/or message flows 300, 400, or 500. In the context of method 600 or 700, and/or message flows 300, 400, or 500, this apparatus may be, for example, an apparatus of a UE (such as a wireless device 1002 that is a UE, as described herein). In the context of the method 800, and/or message flows 300, 400, or 500, this apparatus may be, for example, an apparatus of a base station (such as a network device 1020 that is a base station, as described herein).

Embodiments contemplated herein include a signal as described in or related to one or more elements of the method 600, 700, or 800, and/or message flows 300, 400, or 500.

Embodiments contemplated herein include a computer program or computer program product having instructions, wherein execution of the program by a processor causes the processor to carry out one or more elements of the method 600, 700 or 800, and/or message flows 300, 400, or 500. In the context of method 600 or 700, and/or message flows 300, 400, or 500, the processor may be a processor of a UE (such as a processor(s) 1004 of a wireless device 1002 that is a UE, as described herein), and the instructions may be, for example, located in the processor and/or on a memory of the UE (such as a memory 1006 of a wireless device 1002 that is a UE, as described herein). In the context of method 800, and/or message flows 300, 400, or 500, the processor may be a processor of a base station (such as a processor(s) 1022 of a network device 1020 that is a base station, as described herein), and the instructions may be, for example, located in the processor and/or on a memory of the base station (such as a memory 1024 of a network device 1020 that is a base station, as described herein).

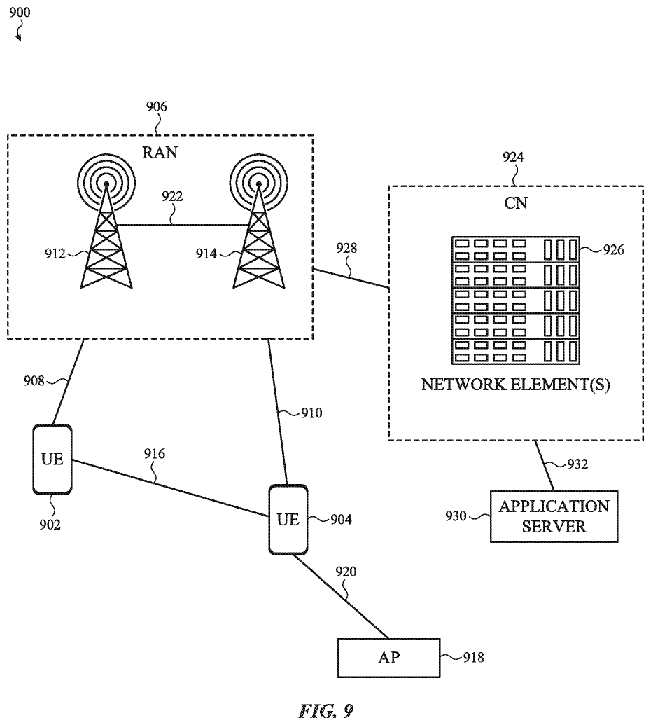

FIG. 9 illustrates an example architecture of a wireless communication system, according to embodiments described herein. The following description is provided for an example wireless communication system 900 that operates in conjunction with the LTE system standards and/or 5G or NR system standards as provided by 3GPP technical specifications.

As shown by FIG. 9, the wireless communication system 900 includes UE 902 and UE 904 (although any number of UEs may be used). In this example, the UE 902 and the UE 904 are illustrated as smartphones (e.g., handheld touchscreen mobile computing devices connectable to one or more cellular networks), but may also comprise any mobile or non-mobile computing device configured for wireless communication.

The UE 902 and UE 904 may be configured to communicatively couple with a RAN 906. In embodiments, the RAN 906 may be NG-RAN, E-UTRAN, etc. The UE 902 and UE 904 utilize connections (or channels) (shown as connection 908 and connection 910, respectively) with the RAN 906, each of which comprises a physical communications interface. The RAN 906 can include one or more base stations, such as base station 912 and base station 914, that enable the connection 908 and connection 910.

In this example, the connection 908 and connection 910 are air interfaces to enable such communicative coupling, and may be consistent with RAT(s) used by the RAN 906, such as, for example, an LTE and/or NR.

In some embodiments, the UE 902 and UE 904 may also directly exchange communication data via a sidelink interface 916. The UE 904 is shown to be configured to access an access point (shown as AP 918) via connection 920. By way of example, the connection 920 can comprise a local wireless connection, such as a connection consistent with any IEEE 802.11 protocol, wherein the AP 918 may comprise a Wi-Fi® router. In this example, the AP 918 may be connected to another network (for example, the Internet) without going through a CN 924.

In embodiments, the UE 902 and UE 904 can be configured to communicate using orthogonal frequency division multiplexing (OFDM) communication signals with each other or with the base station 912 and/or the base station 914 over a multicarrier communication channel in accordance with various communication techniques, such as, but not limited to, an orthogonal frequency division multiple access (OFDMA) communication technique (e.g., for downlink communications) or a single carrier frequency division multiple access (SC-FDMA) communication technique (e.g., for uplink and ProSe or sidelink communications), although the scope of the embodiments is not limited in this respect. The OFDM signals can comprise a plurality of orthogonal subcarriers.

In some embodiments, all or parts of the base station 912 or base station 914 may be implemented as one or more software entities running on server computers as part of a virtual network. In addition, or in other embodiments, the base station 912 or base station 914 may be configured to communicate with one another via interface 922. In embodiments where the wireless communication system 900 is an LTE system (e.g., when the CN 924 is an EPC), the interface 922 may be an X2 interface. The X2 interface may be defined between two or more base stations (e.g., two or more eNBs and the like) that connect to an EPC, and/or between two eNBs connecting to the EPC. In embodiments where the wireless communication system 900 is an NR system (e.g., when CN 924 is a 5GC), the interface 922 may be an Xn interface. The Xn interface is defined between two or more base stations (e.g., two or more gNBs and the like) that connect to 5GC, between a base station 912 (e.g., a gNB) connecting to 5GC and an eNB, and/or between two eNBs connecting to 5GC (e.g., CN 924).

The RAN 906 is shown to be communicatively coupled to the CN 924. The CN 924 may comprise one or more network elements 926, which are configured to offer various data and telecommunications services to customers/subscribers (e.g., users of UE 902 and UE 904) who are connected to the CN 924 via the RAN 906. The components of the CN 924 may be implemented in one physical device or separate physical devices including components to read and execute instructions from a machine-readable or computer-readable medium (e.g., a non-transitory machine-readable storage medium).

In embodiments, the CN 924 may be an EPC, and the RAN 906 may be connected with the CN 924 via an S1 interface 928. In embodiments, the S1 interface 928 may be split into two parts, an S1 user plane (S1-U) interface, which carries traffic data between the base station 912 or base station 914 and a serving gateway (S-GW), and the S1-MME interface, which is a signaling interface between the base station 912 or base station 914 and mobility management entities (MMEs).

In embodiments, the CN 924 may be a 5GC, and the RAN 906 may be connected with the CN 924 via an NG interface 928. In embodiments, the NG interface 928 may be split into two parts, an NG user plane (NG-U) interface, which carries traffic data between the base station 912 or base station 914 and a user plane function (UPF), and the S1 control plane (NG-C) interface, which is a signaling interface between the base station 912 or base station 914 and access and mobility management functions (AMFs).

Generally, an application server 930 may be an element offering applications that use internet protocol (IP) bearer resources with the CN 924 (e.g., packet switched data services). The application server 930 can also be configured to support one or more communication services (e.g., VoIP sessions, group communication sessions, etc.) for the UE 902 and UE 904 via the CN 924. The application server 930 may communicate with the CN 924 through an IP communications interface 932.

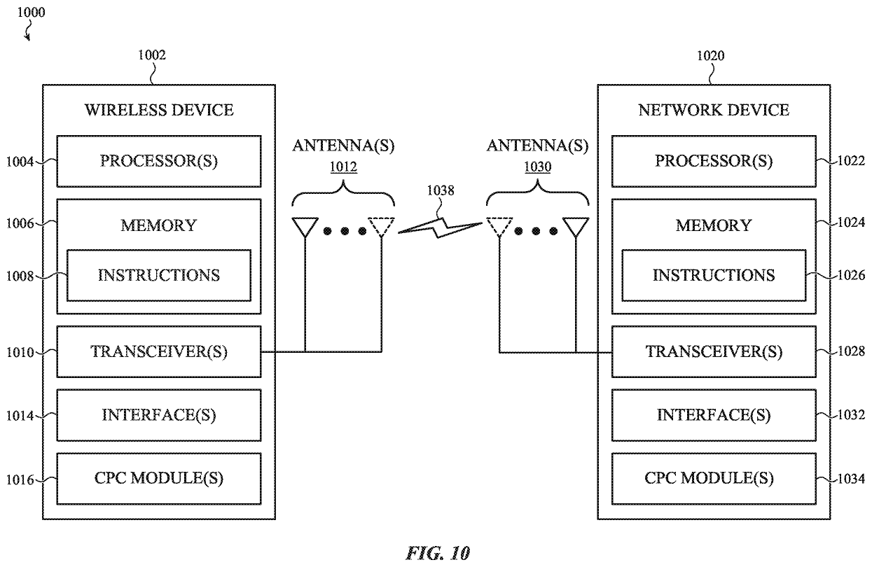

FIG. 10 illustrates a system 1000 for performing signaling 1038 between a wireless device 1002 and a network device 1020, according to embodiments described herein. The system 1000 may be a portion of a wireless communication system as herein described. The wireless device 1002 may be, for example, a UE of a wireless communication system. The network device 1020 may be, for example, a base station (e.g., an eNB or a gNB) of a wireless communication system.

The wireless device 1002 may include one or more processor(s) 1004. The processor(s) 1004 may execute instructions such that various operations of the wireless device 1002 are performed, as described herein. The processor(s) 1004 may include one or more baseband processors implemented using, for example, a central processing unit (CPU), a digital signal processor (DSP), an application specific integrated circuit (ASIC), a controller, a field programmable gate array (FPGA) device, another hardware device, a firmware device, or any combination thereof configured to perform the operations described herein.

The wireless device 1002 may include a memory 1006. The memory 1006 may be a non-transitory computer-readable storage medium that stores instructions 1008 (which may include, for example, the instructions being executed by the processor(s) 1004). The instructions 1008 may also be referred to as program code or a computer program. The memory 1006 may also store data used by, and results computed by, the processor(s) 1004.

The wireless device 1002 may include one or more transceiver(s) 1010 that may include radio frequency (RF) transmitter and/or receiver circuitry that use the antenna(s) 1012 of the wireless device 1002 to facilitate signaling (e.g., the signaling 1038) to and/or from the wireless device 1002 with other devices (e.g., the network device 1020) according to corresponding RATs.

The wireless device 1002 may include one or more antenna(s) 1012 (e.g., one, two, four, or more). For embodiments with multiple antenna(s) 1012, the wireless device 1002 may leverage the spatial diversity of such multiple antenna(s) 1012 to send and/or receive multiple different data streams on the same time and frequency resources. This behavior may be referred to as, for example, multiple input multiple output (MIMO) behavior (referring to the multiple antennas used at each of a transmitting device and a receiving device that enable this aspect). MIMO transmissions by the wireless device 1002 may be accomplished according to precoding (or digital beamforming) that is applied at the wireless device 1002 that multiplexes the data streams across the antenna(s) 1012 according to known or assumed channel characteristics such that each data stream is received with an appropriate signal strength relative to other streams and at a desired location in the spatial domain (e.g., the location of a receiver associated with that data stream). Some embodiments may use single user MIMO (SU-MIMO) methods (where the data streams are all directed to a single receiver) and/or multi user MIMO (MU-MIMO) methods (where individual data streams may be directed to individual (different) receivers in different locations in the spatial domain).

In some embodiments having multiple antennas, the wireless device 1002 may implement analog beamforming techniques, whereby phases of the signals sent by the antenna(s) 1012 are relatively adjusted such that the (joint) transmission of the antenna(s) 1012 can be directed (this is sometimes referred to as beam steering).

The wireless device 1002 may include one or more interface(s) 1014. The interface(s) 1014 may be used to provide input to or output from the wireless device 1002. For example, a wireless device 1002 that is a UE may include interface(s) 1014 such as microphones, speakers, a touchscreen, buttons, and the like in order to allow for input and/or output to the UE by a user of the UE. Other interfaces of such a UE may be made up of transmitters, receivers, and other circuitry (e.g., other than the transceiver(s) 1010/antenna(s) 1012 already described) that allow for communication between the UE and other devices and may operate according to known protocols (e.g., Wi-Fi®, Bluetooth®, and the like).

The wireless device 1002 may include a CPC module 1016. The CPC module 1016 may be implemented via hardware, software, or combinations thereof. For example, the CPC module 1016 may be implemented as a processor, circuit, and/or instructions 1008 stored in the memory 1006 and executed by the processor(s) 1004. In some examples, the CPC module 1016 may be integrated within the processor(s) 1004 and/or the transceiver(s) 1010. For example, the CPC module 1016 may be implemented by a combination of software components (e.g., executed by a DSP or a general processor) and hardware components (e.g., logic gates and circuitry) within the processor(s) 1004 or the transceiver(s) 1010.

The CPC module 1016 may be used for various aspects of the present disclosure, for example, aspects of FIGS. 3-8, from the UE perspective. The CPC module 1016 may be configured to, for example, receive configuration information from a base station, and perform a CPC procedure, as described herein, in accordance with some embodiments.

The network device 1020 may include one or more processor(s) 1022. The processor(s) 1022 may execute instructions such that various operations of the network device 1020 are performed, as described herein. The processor(s) 1022 may include one or more baseband processors implemented using, for example, a CPU, a DSP, an ASIC, a controller, an FPGA device, another hardware device, a firmware device, or any combination thereof configured to perform the operations described herein.

The network device 1020 may include a memory 1024. The memory 1024 may be a non-transitory computer-readable storage medium that stores instructions 1026 (which may include, for example, the instructions being executed by the processor(s) 1022). The instructions 1026 may also be referred to as program code or a computer program. The memory 1024 may also store data used by, and results computed by, the processor(s) 1022.

The network device 1020 may include one or more transceiver(s) 1028 that may include RF transmitter and/or receiver circuitry that use the antenna(s) 1030 of the network device 1020 to facilitate signaling (e.g., the signaling 1038) to and/or from the network device 1020 with other devices (e.g., the wireless device 1002) according to corresponding RATs.

The network device 1020 may include one or more antenna(s) 1030 (e.g., one, two, four, or more). In embodiments having multiple antenna(s) 1030, the network device 1020 may perform MIMO, digital beamforming, analog beamforming, beam steering, etc., as has been described.

The network device 1020 may include one or more interface(s) 1032. The interface(s) 1032 may be used to provide input to or output from the network device 1020. For example, a network device 1020 that is a base station may include interface(s) 1032 made up of transmitters, receivers, and other circuitry (e.g., other than the transceiver(s) 1028/antenna(s) 1030 already described) that enables the base station to communicate with other equipment in a core network, and/or that enables the base station to communicate with external networks, computers, databases, and the like for purposes of operations, administration, and maintenance of the base station or other equipment operably connected thereto.

The network device 1020 may include a CPC module 1034. The CPC module 1034 may be implemented via hardware, software, or combinations thereof. For example, the CPC module 1034 may be implemented as a processor, circuit, and/or instructions 1026 stored in the memory 1024 and executed by the processor(s) 1022. In some examples, the CPC module 1034 may be integrated within the processor(s) 1022 and/or the transceiver(s) 1028. For example, the CPC module 1034 may be implemented by a combination of software components (e.g., executed by a DSP or a general processor) and hardware components (e.g., logic gates and circuitry) within the processor(s) 1022 or the transceiver(s) 1028.

The CPC module 1034 may be used for various aspects of the present disclosure, for example, aspects of FIGS. 3-8, from a base station perspective. The CPC module 1034 may be configured to, for example, transmit, to the UE and candidate SNs, configurations, as described herein, in accordance with some embodiments.

For one or more embodiments, at least one of the components set forth in one or more of the preceding figures may be configured to perform one or more operations, techniques, processes, and/or methods as set forth herein. For example, a baseband processor as described herein in connection with one or more of the preceding figures may be configured to operate in accordance with one or more of the examples set forth herein. For another example, circuitry associated with a UE, base station, network element, etc. as described above in connection with one or more of the preceding figures may be configured to operate in accordance with one or more of the examples set forth herein.

Any of the above described embodiments may be combined with any other embodiment (or combination of embodiments), unless explicitly stated otherwise. The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

Embodiments and implementations of the systems and methods described herein may include various operations, which may be embodied in machine-executable instructions to be executed by a computer system. A computer system may include one or more general-purpose or special-purpose computers (or other electronic devices). The computer system may include hardware components that include specific logic for performing the operations or may include a combination of hardware, software, and/or firmware.

It should be recognized that the systems described herein include descriptions of specific embodiments. These embodiments can be combined into single systems, partially combined into other systems, split into multiple systems or divided or combined in other ways. In addition, it is contemplated that parameters, attributes, aspects, etc. of one embodiment can be used in another embodiment. The parameters, attributes, aspects, etc. are merely described in one or more embodiments for clarity, and it is recognized that the parameters, attributes, aspects, etc. can be combined with or substituted for parameters, attributes, aspects, etc. of another embodiment unless specifically disclaimed herein.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

Although the foregoing has been described in some detail for purposes of clarity, it will be apparent that changes and modifications may be made without departing from the principles thereof. It should be noted that there are many alternative ways of implementing both the processes and apparatuses described herein. Accordingly, the present embodiments are to be considered illustrative and not restrictive, and the description is not to be limited to the details given herein, but may be modified within the scope and equivalents of the appended claims.

We claim:

1. A user equipment (UE), comprising:
a transceiver; and
a processor configured to:
connect the UE, via the transceiver, with a plurality of radio access network (RAN) nodes including at least one RAN node configured as a master node for the UE, and at least two RAN nodes configured as secondary nodes for the UE;
receive, from the master node and via the transceiver, secondary cell group (SCG) configuration information including a respective security configuration structure for each secondary node of the at least two secondary nodes; and
after satisfying a conditional primary secondary cell (PSCell) change condition associated with connecting to a first secondary node of the at least two secondary nodes:
derive a secondary node security key (K_{SN}) corresponding to the first secondary node using a first security configuration structure associated with the first secondary node;
perform an initial access procedure with the first secondary node using the derived K_{SN};
update a second security configuration structure associated with a second secondary node; and
communicate the updated second security configuration structure associated with the second secondary node to the master node.

2. The UE of claim 1, wherein the respective security configuration structure for each secondary node of the at least two secondary nodes comprises a respective secondary node key counter (K_{SN}-Counter) and a respective secondary node key offset (K_{SN}-Offset).

3. The UE of claim 2, wherein the K_{SN} is derived using the respective K_{SN}-Counter of the respective security configuration structure associated with the first secondary node.

4. The UE of claim 2, wherein the second security configuration structure associated with the second secondary node is updated by updating the respective K_{SN}-Counter of the respective security configuration structure associated with the second secondary node based on the respective K_{SN}-Offset associated with the second secondary node.

5. The UE of claim 4, wherein:
the communication of the updated second security configuration structure associated with the second secondary node to the master node includes the respective K_{SN}-Counter associated with the second secondary node to the master node.

6. The UE of claim 2, wherein:
the processor is configured to,
update the respective K_{SN}-Counter of the respective security configuration structure associated with the first secondary node using the respective K_{SN}-Offset of the respective security configuration structure associated with the first secondary node.

7. The UE of claim 2, wherein:
the processor is further configured,
after satisfying a conditional primary secondary cell (PSCell) change condition associated with connecting to the second secondary node:
derive a K_{SN} corresponding to the second secondary node using the second security configuration structure associated with the second secondary node;
perform an initial access procedure with the second secondary node using the derived K_{SN};
update the first security configuration structure associated with the first secondary node; and
communicate the updated first security configuration structure associated with the first secondary node to the master node.

8. The UE of claim 7, wherein the updated first security configuration structure associated with the first secondary node includes the respective K_{SN}-Counter of the respective security configuration structure associated with the first secondary node based on the respective K_{SN}-Offset associated with the first secondary node.

9. The UE of claim 8, wherein:
the processor is configured to,
increment the respective K_{SN}-Counter of the respective security configuration structure associated with the first secondary node or the second secondary node in accordance with the respective K_{SN}-Offset of the respective security configuration structure associated with the first secondary node or the second secondary node, respectively.

10. The UE of claim 7, wherein:
the processor is further configured to,
add the respective K_{SN}-Offset of the respective security configuration structure associated with the first secondary node to the respective K_{SN}-Counter of the respective security configuration structure associated with the first secondary node.

11. The UE of claim 7, wherein:
the processor is further configured to,
add the respective K_{SN}-Offset of the respective security configuration structure associated with the second secondary node to the respective K_{SN}-Counter of the respective security configuration structure associated with the second secondary node.

12. The UE of claim 7, wherein:
the master node is a first master node; and
the processor is configured to,
release the respective K_{SN}-Counter and the respective K_{SN}-Offset of the respective security configuration structure corresponding to each of the at least two secondary nodes upon handover of the UE to a primary cell having a second master node that is different from the first master node.

13. The UE of claim 7, wherein:
the master node is a first master node; and
the processor is configured to,
release the respective K_{SN}-Counter and the respective K_{SN}-Offset of the respective security configuration structure corresponding to each of the at least two secondary nodes upon a radio link failure at a primary cell having the first master node.

14. The UE of claim 7, wherein:
the processor is configured to,
release the respective K_{SN}-Counter and the respective K_{SN}-Offset of the respective security configuration structure corresponding to each of the at least two secondary nodes upon a secondary cell group (SCG) failure corresponding to any of the at least two secondary nodes.

15. The UE of claim 7, wherein:
the processor is configured to,
release the respective K_{SN}-Counter and the respective K_{SN}-Offset of the respective security configuration structure corresponding to a secondary node of the at least two secondary nodes upon a secondary cell group (SCG) failure associated with the secondary node.

16. A user equipment (UE), comprising:
a transceiver; and
a processor configured to:
connect the UE, via the transceiver, with a plurality of radio access network (RAN) nodes including at least one RAN node configured as a master node for the UE, and at least two RAN nodes configured as secondary nodes for the UE;
receive, from the master node and via the transceiver, secondary cell group (SCG) configuration information including a secondary node key counter (K_{SN}-Counter) corresponding to each of at least two secondary nodes and a secondary node key offset (K_{SN}-Offset) corresponding to each of the at least two secondary nodes; and
after satisfying a conditional primary secondary cell (PSCell) change condition associated with connecting to a first secondary node of the at least two secondary nodes:
derive a secondary node security key (K_{SN}) corresponding to the first secondary node using the K_{SN}-Counter associated with the first secondary node;
perform an initial access procedure with the first secondary node using the derived K_{SN};
update the K_{SN}-Counter associated with the first secondary node in accord with the K_{SN}-Offset associated with the first secondary node; and
communicate the updated K_{SN}-Counter associated with the first secondary node to the master node.

17. The UE of claim 16, wherein:
the processor is further configured to,
after satisfying a conditional primary secondary cell (PSCell) change condition associated with connecting to a second secondary node:
derive a K_{SN} corresponding to the second secondary node using the K_{SN}-Counter associated with the second secondary node;
perform an initial access procedure with the second secondary node using the derived K_{SN} corresponding to the second secondary node;
update the K_{SN}-Counter associated with the second secondary node in accord with the K_{SN}-Offset associated with the second secondary node; and
communicate the updated K_{SN}-Counter associated with the second secondary node to the master node.

18. The UE of claim 16, wherein:
the processor is configured to,
derive the K_{SN} corresponding to the first secondary node by adding the K_{SN}-Offset associated with the first secondary node to the K_{SN}-Counter associated with the first secondary node.

19. The UE of claim 16, wherein:
the master node is a first master node; and
the processor is further configured to,
release the K_{SN}-Counter and the K_{SN}-Offset corresponding to each of the at least two secondary nodes upon handover of the UE to a primary cell having a second master node that is different from the first master node;
release the K_{SN}-Counter and the K_{SN}-Offset corresponding to each of the at least two secondary nodes upon a radio link failure at a primary cell having the first master node;
release the K_{SN}-Counter and the K_{SN}-Offset corresponding to each of the at least two secondary nodes upon a secondary cell group (SCG) failure corresponding to any of the at least two secondary nodes; or
release the K_{SN}-Counter and the K_{SN}-Offset corresponding to a secondary node of the at least two secondary nodes upon a secondary cell group (SCG) failure associated with the secondary node.

20. A base station, comprising:
a transceiver; and
a processor configured to:
transmit, to a user equipment (UE) and via the transceiver, secondary cell group (SCG) configuration information including a secondary node key counter (K_{SN}-Counter) corresponding to each of at least two secondary nodes of a plurality of radio access network (RAN) nodes, the base station is a master node of the plurality of RAN nodes;
transmit, to each of the at least two secondary nodes and via the transceiver, a secondary node security key (K_{SN}) corresponding to each of the at least two secondary nodes, the K_{SN} corresponding to each of the at least two secondary nodes is calculated based on the K_{SN}-Counter;
after satisfying a conditional primary secondary cell (PSCell) change condition associated with connecting to a first secondary node of the at least two secondary nodes:
receive, from the UE and via the transceiver, an update to the K_{SN}-Counter associated with a second secondary node, the K_{SN}-Counter associated with the second secondary node is updated by the UE in accord with a secondary node key offset (K_{SN}-Offset) associated with the second secondary node;
recalculate the K_{SN} associated with the second secondary node using the updated K_{SN}-Counter associated with the second secondary node; and
transmit the recalculated K_{SN} associated with the second secondary node to the second secondary node; wherein:
the SCG configuration information transmitted to the UE further comprises whether the UE needs to update the K_{SN}-Counter corresponding to a secondary node of the at least two secondary nodes or each secondary node of the at least two secondary nodes in response to the conditional PSCell change condition being satisfied with respect the first secondary node or the second secondary node; and
the K_{SN}-Offset associated with the first secondary node or the second secondary node is either derived by the UE based on a physical cell ID (PCI) and/or an absolute radio frequency channel number (ARFCN), or transmitted to the UE in the SCG configuration information.
